(19) United States
(12) Patent Application Publication
(10) Pub. No.: US 2014/0369740 A1
(43) Pub. Date: Dec. 18, 2014

(54) COUPLING DEVICE

(71) Applicant: PEI-CHUAN MA, Taipei City (TW)

(72) Inventor: PEI-CHUAN MA, Taipei City (TW)

(21) Appl. No.: 13/920,098

(22) Filed: Jun. 18, 2013

(51) Int. Cl. F16B 7/04

(52) U.S. Cl. CPC F16B 7/0446
USPC 403/205

(57) ABSTRACT

The coupling device contains at least an orthogonal joint member, a number of connector members, and at least two oblique joint members. The orthogonal joint member has at least 6 faces, 5 of which are configured with a through hole, and a through slot and a blind trough extended from the through hole. Each connector member contains an axial pin, a wing plate on a front tip of the axial pin. Each oblique joint member is L-shaped, and each of the two outer faces of the L-shaped body is configured with a through hole, and a through slot and a blind trough extended from the through hole. A coupling column is configured behind one of the two outer faces. With the coupling device, a number of beams can be joined into a framework to be used as a storage shelf or the skeleton of a game house.

### TECHNICAL FIELD OF THE INVENTION

The present invention is generally related to coupling devices, and more particular to a coupling device for joining beams into a framework of a storage shelf or a skeleton of a game house.

### DESCRIPTION OF THE PRIOR ART

Conventional storage shelves are usually both difficult and time-consuming to assemble and disassemble. On the other hand, conventional game houses usually have a fixed skeleton, which is not only inflexible but also inconvenient to move.

### SUMMARY OF THE INVENTION

Therefore, a major objective of the present invention is to provide a coupling device capable of joining a number of beams into a storage shelf or a skeleton for a game house of various shapes with ease and convenience.

The coupling device contains at least an orthogonal joint member, a number of connector members, and at least two oblique joint members. The orthogonal joint member has at least 6 faces, 5 of which are configured with a through hole, and a through slot and a blind trough extended from the through hole. Each connector member contains an axial pin, a wing plate on a front tip of the axial pin. Each oblique joint member is L-shaped, and each of the two outer faces of the L-shaped body is configured with a through hole, and a through slot and a blind trough extended from the through hole. A coupling column is configured behind one of the two outer faces. With the coupling device, a number of beams can be joined into a framework of a specific shape to be used as a storage shelf or the skeleton of a game house.

Each connector member further contains a rib for embedment into the blind trough of an orthogonal or oblique joint member so as to secure the connection between the members.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an orthogonal joint member and two connector members of a coupling device according to an embodiment of the present invention.

FIG. 2 is a perspective diagram showing an oblique joint member of a coupling device according to an embodiment of the present invention.

FIG. 3 is a perspective diagram showing the oblique joint member of FIG. 2 from a different perspective.

FIGS. 4 and 5 depict a first application of the coupling device shown in FIGS. 1 to 3.

FIGS. 6 and 7 are schematic diagrams showing the connection process of a connector member to an orthogonal or oblique joint member of the coupling device of the present invention.

FIGS. 8 to 10 depict a second application of the coupling device shown in FIGS. 1 to 3.

FIGS. 11 and 12 depict a third application of the coupling device shown in FIGS. 1 to 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

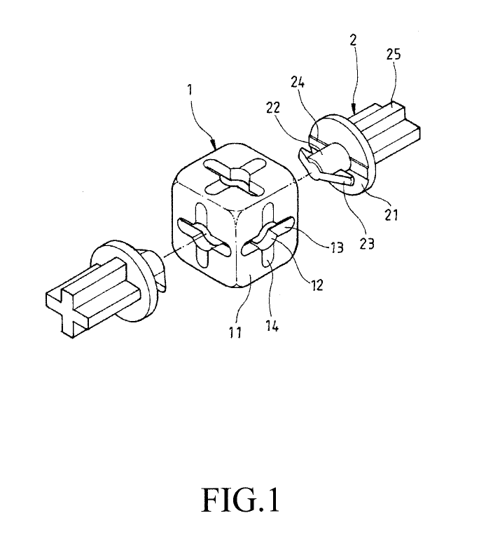

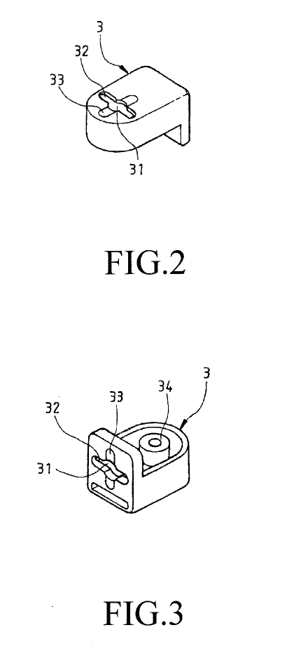

The coupling device of the present invention contains at least an orthogonal joint member, a number of connector members, and at least two oblique joint members. FIG. 1 is a perspective diagram showing a joint member 1 and two connector members 2 according to an embodiment of the present invention. As illustrated, the orthogonal joint member 1 is hollow, and has at least 6 faces 11, 5 of which are configured with a through hole 12. Each through hole 12 is extended along the face 11 to form a through slot 13 and a blind trough 14. The through slot 13 and the blind trough 14 are arranged into a cross shape. Each connector member 2 contains a face plate 21, an axial pin 22 extended from a front side of the face plate 21, a wing plate 23 on a front tip of the axial pin 22, a rib 24 on the front side of the face plate 21 parallel to the wing plate 23, and a plug 25 behind the face plate 21 having axial ribs.

Each oblique joint member 3 is L-shaped, and each of the two outer faces of the L-shaped body are configured with a through hole 31. Each through hole 31 is extended along the face to form a through slot 32 and a blind trough 33. The through slot 32 and the blind trough 33 are arranged into a cross shape. A coupling column 34 is configured behind one of the two outer faces.

With the coupling device described above, a number of tubular beams can be joined together by the orthogonal joint members 1, connector members 2, and the oblique joint members 3 into a framework of a specific shape to be used as, for example, a storage shelf or the skeleton of a game house.

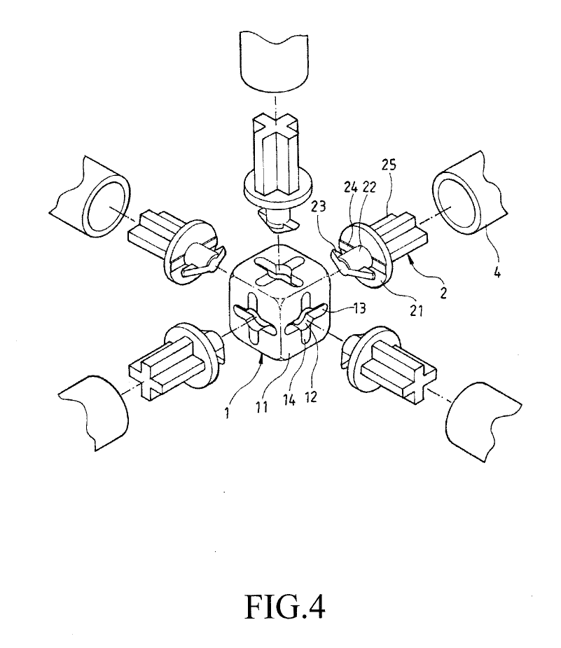

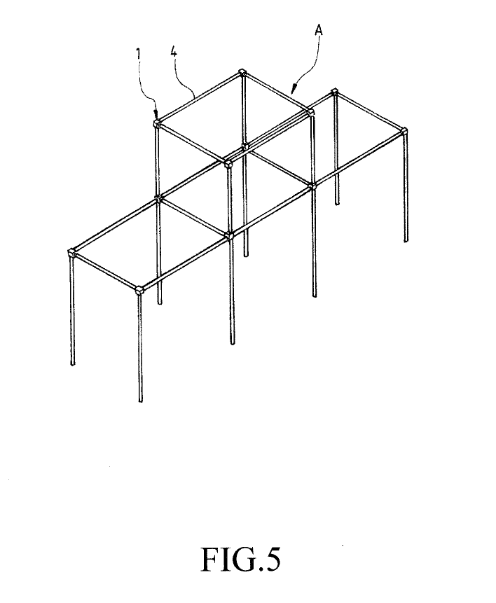

More specifically, as shown in FIGS. 4 and 5, each connector member 2 has its plug 25 stuffed into a tubular beam 4. Then, each tubular beam 4 is joined perpendicularly to a face 11 of an orthogonal joint member 1 by plugging the axial pin 22 and the wing plate 23 of the connector member 2 into a through hole 12 and a through slot 13 on the face 11. The tubular beams 4 are as such assembled into a framework A.

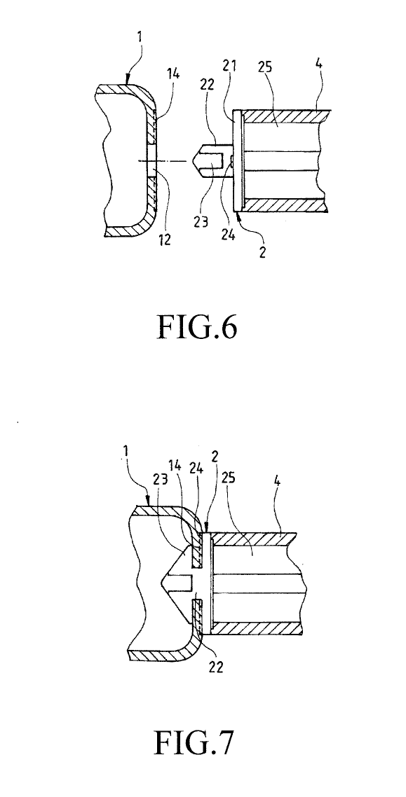

As further shown in FIGS. 6 and 7, after the axial pin 22 and the wing plate 23 of the connection member 2 is plugged into a through hole 12 and a through slot 13, the connection member 2 is turned 90 degrees so that the wing plate 23 will not fall out of the through slot 13 and the rib 24 is embedded into the blind trough 14. As such, the connection between the orthogonal joint member 1 and the connector member 2 is secured.

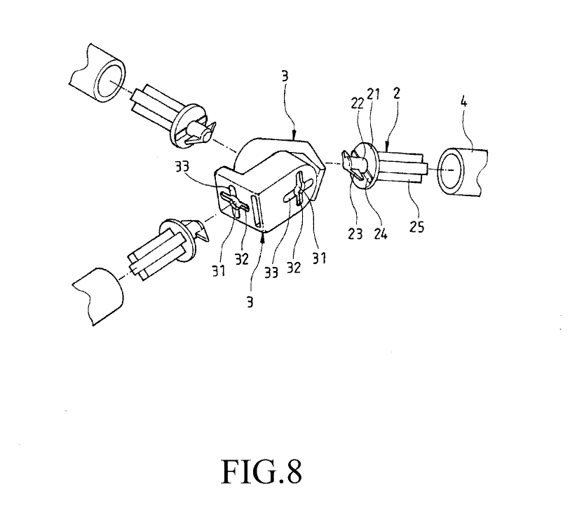

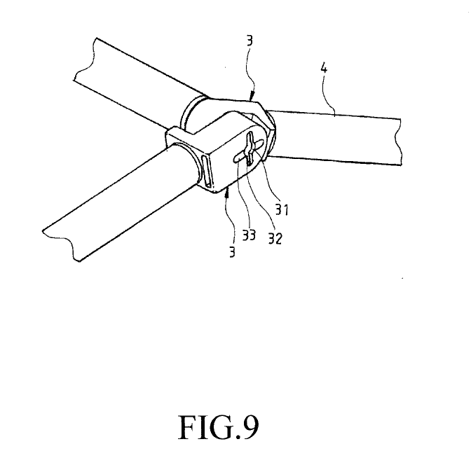

As shown in FIGS. 8 and 9, two oblique joint members 3 are pin-joined together by their coupling columns 34 such as by running a rivet through them. The two oblique joint members 3 as such can rotate relative to each other. Then, a number of connector members 2 have their plugs 25 stuffed into tubular beams 4. Then, each tubular beam 4 is joined perpendicularly to a face of an oblique joint member 3 by plugging the axial pin 22 and the wing plate 23 of the connector member 2 into a through hole 31 and a through slot 32 on the face. By rotating the oblique joint members 3, the tubular beams 4 can have various included angles between them.

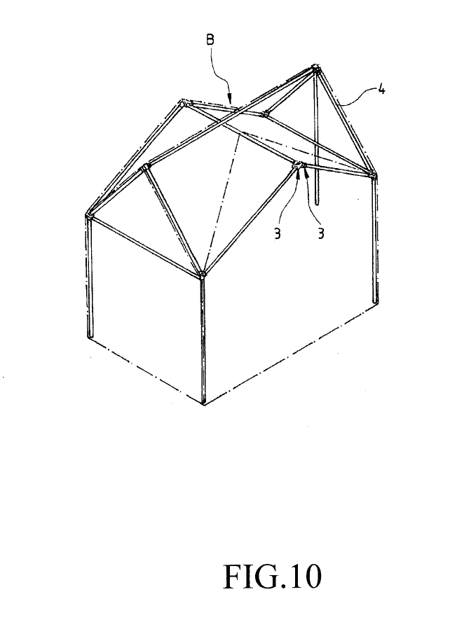

Through the assembly described above and shown in FIGS. 8 and 9, a skeleton B for a game house can be constructed as shown in FIG. 10. The game house as such can be easily and conveniently disassembled, stored, and assembled into different shapes.

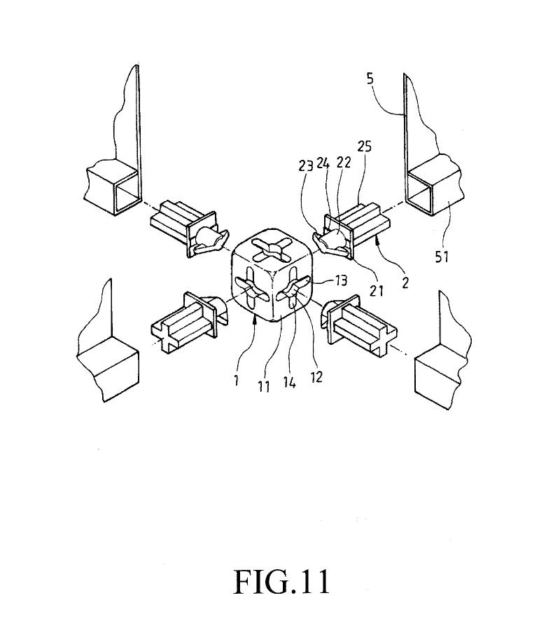

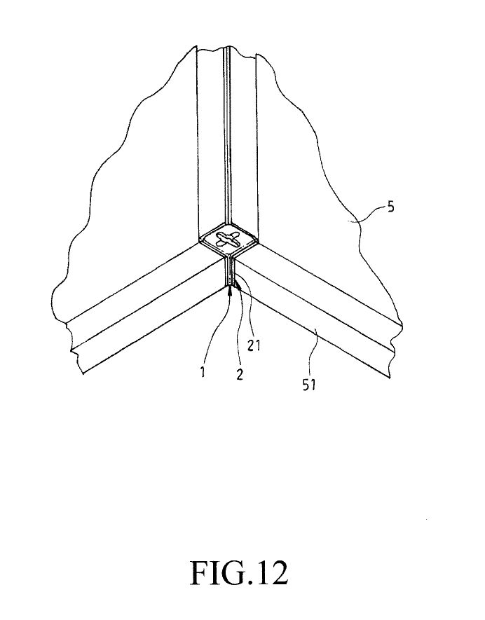

As shown in FIGS. 11 and 12, a number of connector members 2 have their plugs 25 stuffed into cuboid channels 51 configured on plates 5. Then, each plate 5 is joined perpendicularly and securely to a face 11 of an orthogonal joint member 1 by plugging the axial pin 22 and the wing plate 23 of the connector member 2 into a through hole 12 and a through slot 13 on the face 11, and then turning the connector member 2 for 90 degrees. The plates 5 are as such assembled into a different type of framework C.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A coupling device for joining a plurality of beams or plates, comprising:
at least an orthogonal joint member comprising six faces, five of which are configured with a first through hole and a first through slot extended from the first through hole;
a plurality of connector members, each comprising a face plate, an axial pin extended from a front side of the face plate, a wing plate on a front tip of the axial pin, and a plug behind the face plate having axial ribs;
at least two L-shaped oblique joint members, each of the two outer faces of the L-shaped body configured with a second through hole and a second through slot extended from the second through hole, a coupling column configured behind one of the two outer faces;
wherein each connector member has its plug stuffed into a beam or a channel on a plate; the oblique joint members are rotatably pin-joined together by their coupling columns; and each beam or plate is joined to an orthogonal or oblique joint member by plugging the axial pin and the wing plate of the connector member into a first or second through hole and a first or second through slot, respectively, and turning the connector member for a degree.

2. The coupling device according to claim 1, wherein each orthogonal further comprises a first blind trough extended from the first through hole on each of the five faces; each connector member further comprises a rib on the front side of the face plate parallel to the wing plate; and, when the connector member is turned, the rib is embedded into the first blind trough.

3. The coupling device according to claim 2, wherein each oblique joint member further comprises a second blind trough extended from the second through hole on each outer face; and, when the connector member is turned, the rib is embedded into the second blind trough.

4. The coupling device according to claim 2, wherein the first through slot and the first blind trough are arranged into a cross shape; and the second through slot and the second blind trough are arranged into a cross shape.
